(19) United States
(12) Patent Application Publication
(10) Pub. No.: US 2025/0236533 A1
(43) Pub. Date: Jul. 24, 2025

(54) OXIDE COMPOSITE POSITIVE ELECTRODE MATERIAL COATED WITH COPPER OXIDE IN SITU, PREPARATION METHOD, AND APPLICATION

(71) Applicant: Institute of Physics, Chinese Academy of Sciences, Beijing (CN)

(72) Inventors: Yongsheng Hu, Beijing (CN); Zilin Hu, Beijing (CN); Xiaohui Rong, Beijing (CN); Liquan Chen, Beijing (CN)

(21) Appl. No.: 19/116,562

(22) PCT Filed: Dec. 13, 2022
(86) PCT No.: PCT/CN2022/138546

§ 371 Date: Mar. 28, 2025

(30) Foreign Application Priority Data
Sep. 27, 2022 (CN) 202211183418.1

(51) Int. Cl. C01G 45/1228; H01M 10/054

(52) U.S. Cl. CPC C01G 45/1228; H01M 10/054; C01P 2002/74; C01P 2002/76; C01P 2004/82; C01P 2006/40

(57) ABSTRACT

An oxide composite positive electrode material coated with copper oxide in-situ, a preparation method therefor, and an application thereof. The chemical general formula of the oxide composite positive electrode material coated with copper oxide in-situ is: γCuO—NaₐCu_{b}Mn_{c}M_{d}O_{2+δ}; in NaₐCu_{b}Mn_{c}MO_{2+δ}, Cu, Mn and M together occupy a transition metal site in a crystal structure; M is an element introduced through doping to substitute for the transition metal site; and γCuO is a coating layer generated in-situ on the surface of NaₐCu_{b}Mn_{c}M_{d}O_{2+β} by the Cu element added in excess during a sintering process for preparing the oxide composite positive electrode material coated with copper oxide in-situ.

### CROSS-REFERENCE TO RELATED APPLICATIONS

This application is a national phase entry under 35 U.S.C. § 371 of International Patent Application PCT/CN2022/138546, filed Dec. 13, 2022, designating the United States of America and published as International Patent Publication WO 2024/066064 A1 on Apr. 4, 2024, which claims the benefit under Article 8 of the Patent Cooperation Treaty of Chinese Patent Application Serial No. 202211183418.1, filed Sep. 27, 2022.

### TECHNICAL FIELD

This disclosure relates to the technical field of sodium-ion battery materials, and, in particular, to an oxide composite positive electrode material coated with copper oxide in-situ, a preparation method therefor and an application thereof.

### BACKGROUND

With the development and progress of society, the demand of human beings for energy is increasing. However, traditional fossil energy resources such as coal, fossil oil, and natural gas have been gradually exhausted, and problems such as urban environmental pollution and greenhouse effect caused thereby are increasingly serious, leading to their restricted applications in many aspects. Therefore, the development of sustainable clean energy has always been the focus of all countries. However, in the process of converting wind energy, solar energy, tidal energy or the like into electrical energy, such renewable energy is greatly restricted by natural conditions and shows obvious time discontinuity and uneven spatial distribution, such that the electricity provided by them is poor in controllability and stability and cannot be directly input into the power grid for use. Hence, the reliable power supply of the power system can be ensured only by providing high-performance large-scale energy storage systems to eliminate the time difference contradiction between power generation and power consumption and to adjust the quality of electric energy. At present, there is an urgent need for large-scale energy storage technologies in the sustainable development of energy in China, and this is also a research hotspot in countries around the world.

Existing methods for energy storage include physical energy storage and chemical energy storage. In the physical energy storage, pumped storage is currently the most used, with the largest energy storage capacity. However, it is limited by geographical location and has a long construction period. Other methods for physical energy storage such as compressed-air energy storage and flywheel energy storage haven't yet been on a scale. Electrochemical energy storage refers to the storage or release of electricity through reversible chemical reactions. It has attracted the widespread attention of people due to its advantages such as high energy conversion efficiency, high power density, long cycle life, short construction period, and low maintenance cost.

Nowadays, the electrochemical energy storage mainly includes several categories such as high-temperature sodium-sulfur batteries, flow batteries, lead-acid batteries and lithium-ion batteries. The operating temperature of sodium-sulfur (Na—S) batteries is 300° C., at which metallic sodium and elemental sulfur are in a molten state. If damage occurs to these batteries at high temperature, it is easy to cause a fire in the battery module. In consequence, there are great safety issues, making large-scale application unavailable. The flow batteries have low energy density and large volume. The lead-acid batteries have low cost and no memory effect compared with Ni—Cd batteries, and thus have always occupied most of the energy storage market to achieve broad application. However, they also have obvious disadvantages. For example, lead may cause serious environmental pollution, and these batteries have low energy density, heavy weight, large volume, and increased maintenance cost. In view of the demand of energy storage systems for characteristics such as low cost, environmental friendliness, long life and high safety performance, lithium-ion and sodium-ion secondary batteries have become important energy storage technologies, among numerous electrochemical energy storage materials.

At present, the lithium-ion batteries for electrochemical energy storage have been widely used in daily life due to their advantages such as high energy density, high cycle stability, long cycle life, small size, light weight and no pollution. Considering that sodium is an alkali metal element like lithium in the periodic table, they have similar physical and chemical properties. Sodium-ion batteries and lithium-ion batteries have similar charge-discharge storage mechanisms. More importantly, sodium is abundant and widely distributed in nature, and has a significant price advantage. In addition to the low price of sodium ions, aluminum foil can be used for both the positive and negative current collectors of sodium-ion batteries, while only copper can be used for the negative electrode of lithium-ion batteries. Obviously, copper is much more expensive than aluminum. Therefore, sodium as the raw material is low in cost and readily available. These advantages have garnered increasing attention for sodium-ion batteries worldwide.

However, the sodium-ion batteries are still in a research stage, and there are no commercial positive electrode materials for the sodium-ion batteries. The current studies of researchers are mainly focused on an oxide positive electrode material NaₓMO₂ (M represents a 3d transition metal element, and may include one or more of, for example, Ti, V, Cr, Fe, Mn, Co, Ni, Cu, Nb, Ru, Mo, Zn, etc.) with a layered structure. Such batteries are based on a reduction reaction, of which the essence lies in the change of valence, i.e., the transfer and drift of electrons. The half-reaction in which electrons are lost is an oxidation reaction, in which case the valence of the positive electrode material increases; and the half-reaction in which electrons are gained is a reduction reaction, in which case the valence of the positive electrode material decreases. Each layered oxide positive electrode material for the sodium-ion batteries introduced above includes transition metal materials allowing for reduction reactions, and the variable-valence transition metals in the initial state of the material are in a lower valence state. However, there are still many cases where the transition metal ions cannot completely alter their valences and their capacity cannot be fully utilized, and the air stability of these positive electrode materials is insufficient, resulting in poor consistency.

### BRIEF SUMMARY

An object of the disclosure is to provide an oxide composite positive electrode material coated with copper oxide in-situ, a preparation method therefor, and an application thereof. Based on the fact that the solid solubility of copper is lower than that of other elements during preparation and synthesis of the material, a positive electrode oxide material is coated in-situ in one step by adding a Cu element in excess to form the positive electrode material coated with copper oxide in-situ on a surface, such that the air stability, conductivity and sodium diffusion capability of the material can be improved, thereby reducing charge transfer impedance and achieving higher initial charge-discharge efficiency, better cycling performance and longer cycle life for the positive electrode material.

To this end, in a first aspect, an embodiment of the disclosure provides an oxide composite positive electrode material coated with copper oxide in-situ, which has a chemical general formula of: γCuO—NaₐCu_{b}Mn_{c}MaO_{2+β},
wherein, in the oxide composite positive electrode material, Cu, Mn and M together occupy a transition metal site in a crystal structure; M is an element introduced through doping to substitute for the transition metal site, and includes one or more of elements of group IIIA, elements of group IV, elements of group VA, non-metallic elements of group VIA, transition metal elements of the fourth periods or transition metal elements of the fifth periods;
the oxide composite positive electrode material is layered, and has a space group of P63/mmc or P63/mcm with a corresponding structure of a P2 phase, or a space group is R3̅m with a corresponding structure of an O3 phase, or a space group is a mixture of P63/mcm and R3̅m with a corresponding structure of a P2/O3 mixed phase;
a, b, c, d and 2+β corresponding to molar percents of corresponding elements, respectively, and respective components in the chemical general formula satisfy conservation of charge and stoichiometric conservation, wherein b+c+d=1, a+2b+4c+md=2 (2+B), 0.66≤a≤1, 0<b≤0.5, 0<c≤0.8, 0<d<0.65, −0.05≤B≤0.05, and m is a valence state of M;
and γCuO is a coating layer generated in-situ on a surface of NaₐCu_{b}Mn_{c}MaO_{2+β} by the Cu element added in excess during a sintering process for preparing the positive electrode material, and γ is a molar ratio of the excessive Cu element in a precursor material, with 0.1%≤γ ≤10%.

Preferably, 2%≤γ≤6%.

In a second aspect, an embodiment of the disclosure provides a preparation method for an oxide composite positive electrode material coated with copper oxide in-situ, wherein the preparation method is a solid-phase method, including:
mixing sodium carbonate with a stoichiometric amount of 100 wt %-108 wt % of sodium as required, an oxide of copper with a stoichiometric amount of 100.1 wt %-110 wt % of copper as required, an oxide of manganese or a carbonate of manganese with a stoichiometric amount as required and an oxide of M or a carbonate of M with a stoichiometric amount as required to form a positive electrode material precursor, wherein M is an element introduced through doping to substitute for a transition metal site, and includes one or more of elements of group IIIA, elements of group IV, elements of group VA,non-metallic elements of group VIA, transition metal elements of the fourth periods or transition metal elements of the fifth periods;
mixing the positive electrode material precursor uniformly by ball milling to obtain precursor powder;
placing the precursor powder in a muffle furnace or a tube furnace, and thermally treating the precursor powder in an air or oxygen atmosphere at 600° C.-1000° C. for 2-24 hours; and
grinding the thermally treated powder to obtain the oxide composite positive electrode material coated with copper oxide in-situ.

In a third aspect, an embodiment of the disclosure provides a preparation method for the oxide composite positive electrode material coated with copper oxide in-situ according, wherein the preparation method is a spray-drying method, including:
mixing sodium carbonate or sodium nitrate with a stoichiometric amount of 100 wt %-110 wt % of sodium as required, a nitrate of copper with a stoichiometric amount of 100.1 wt %-110 wt % of copper as required, a nitrate of manganese with a stoichiometric amount as required and an oxide of M or a carbonate of M with a stoichiometric amount as required to form a positive electrode material precursor, wherein M is an element introduced through doping to substitute for a transition metal site, and includes one or more of elements of group IIIA, elements of group IV, elements of group VA,non-metallic elements of group VIA, transition metal elements of the fourth periods or transition metal elements of the fifth periods;
adding ethanol or water to the positive electrode material precursor, and stirring evenly to form a slurry;
spray-drying the slurry to obtain precursor powder;
placing the precursor powder in a muffle furnace or a tube furnace, and thermally treating the precursor powder in an air or oxygen atmosphere at 600° C.-1000° C. for 2-24 hours; and
grinding the thermally treated powder to obtain the oxide composite positive electrode material coated with copper oxide in-situ on a surface.

In a fourth aspect, an embodiment of the disclosure provides a preparation method for the oxide composite positive electrode material coated with copper oxide in-situ, wherein the preparation method is a burning method, including:
mixing sodium nitrate with a stoichiometric amount of 100 wt %-110 wt % of sodium as required, a nitrate of copper with a stoichiometric amount of 100.1 wt %-110 wt % of copper as required, a nitrate of manganese with a stoichiometric amount as required and a nitrate of M with a stoichiometric amount as required to form a positive electrode material precursor, wherein M is an element introduced through doping to substitute for a transition metal site, and includes one or more of elements of group IIIA, elements of group IV, elements of group VA, non-metallic elements of group VIA, transition metal elements of the fourth periods or transition metal elements of the fifth periods;
adding acetylacetone to the positive electrode material precursor, and stirring evenly to form a slurry;
drying the slurry to obtain precursor powder;
placing the precursor powder in a muffle furnace or a tube furnace, and thermally treating the precursor powder in an air or oxygen atmosphere at 600° C.-1000° C. for 2-24 hours; and
grinding the thermally treated powder to obtain the oxide composite positive electrode material coated with copper oxide in-situ on a surface.

In a fifth aspect, an embodiment of the disclosure provides a preparation method for the oxide composite positive electrode material coated with copper oxide in-situ, wherein the preparation method is a sol-gel method, including:
dissolving and mixing a sodium salt with a stoichiometric amount of 100 wt %-110 wt % of sodium as required, a nitrate of copper or a sulfate of copper with a stoichiometric amount of 100.1 wt %-110 wt % of copper as required, a nitrate of manganese or a sulfate of manganese with a stoichiometric amount and a nitrate of M or a sulfate of M with a stoichiometric amount as required in water or ethanol to form a precursor solution, wherein M is an element introduced through doping to substitute for a transition metal site, and includes one or more of elements of group IIIA, elements of group IV, elements of group VA,non-metallic elements of group VIA, transition metal elements of the fourth periods or transition metal elements of the fifth periods, and the sodium salt includes: sodium acetate, sodium nitrate, sodium carbonate or sodium sulfate;
stirring the precursor solution at 50° C.-100° C., adding a chelating agent with an amount 2-6 times a total molar amount of transition metal, and evaporating a resultant to dryness to form a precursor gel, wherein the transition metal includes Cu and M;
placing the precursor gel in a crucible, and pre-sintering the precursor gel at 200° C.-500° C. for 2 hours;
placing powder resulting from the pre-sintering in a muffle furnace or tube furnace, and thermally treating the powder in an air or oxygen atmosphere at 600° C.-1000° C. for 2-24 hours; and
grinding the thermally treated powder to obtain the oxide composite positive electrode material coated with copper oxide in-situ on a surface.

In a sixth aspect, an embodiment of the disclosure provides a preparation method for the oxide composite positive electrode material coated with copper oxide in-situ, wherein the preparation method is a co-precipitation method, including:
dissolving and mixing a nitrate of copper with a stoichiometric amount of 100.1 wt %-110 wt % of copper as required, a nitrate of manganese with a stoichiometric amount as required and a nitrate of M with a stoichiometric amount as required in water to form a precursor solution, wherein M is an element introduced through doping to substitute for a transition metal site, and includes one or more of elements of group IIIA, elements of group IV, elements of group VA,non-metallic elements of group VIA, transition metal elements of the fourth periods or transition metal elements of the fifth periods;
dropwise adding the precursor solution into an aqueous ammonia solution with a pH between 7 and 14 by using a peristaltic pump to produce a precipitate;
cleaning the obtained precipitate with deionized water, drying the precipitate, and mixing the precipitate and sodium carbonate with a stoichiometric amount of 100 wt %-110 wt % of sodium as required evenly at a stoichiometric ratio to obtain a precursor;
placing the precursor in a crucible or porcelain boat, and thermally treating the precursor in an air or oxygen atmosphere at 600° C.-1000° C. for 2-24 hours; and
grinding the thermally treated powder to obtain the oxide composite positive electrode material coated with copper oxide in-situ on a surface.

In a seventh aspect, an embodiment of the disclosure provides a positive electrode piece for a sodium-ion secondary battery. The positive electrode piece includes a current collector, a conductive additive coated on the current collector, a binder, and the oxide composite positive electrode material coated with copper oxide in-situ as defined in the first aspect above.

In an eighth aspect, an embodiment of the disclosure provides a sodium-ion secondary battery including the positive electrode piece as defined in the seventh aspect above.

In a ninth aspect, an embodiment of the disclosure provides use of the sodium-ion secondary battery according as defined in the eighth aspect above, wherein the sodium-ion secondary battery is for use in large-scale energy storage equipment in solar power generation, wind power generation, peak load regulation of a smart power grid, distributed power stations, back-up sources or communication base stations.

According to the oxide composite positive electrode material coated with copper oxide in-situ in the embodiments of the disclosure, a copper oxide coating layer generated in-situ is formed with copper oxide enriched on the surface based on the fact that the solid solubility of copper is lower than that of other elements; the coating layer greatly reduces residual alkali generated due to contact of the surface of the material with the air, and significantly improves the stability in air; and the material achieves higher conductivity and sodium diffusion capability, lower charge transfer impedance, higher initial charge-discharge efficiency, better cycling performance and, in particular, longer cycle life.

### BRIEF DESCRIPTION OF THE DRAWINGS

FIG. 1 shows a schematic diagram of a process of preparing an oxide composite positive electrode material coated with copper oxide in-situ by sintering according to an embodiment of the disclosure;

FIG. 2 shows X-ray diffraction (XRD) patterns of oxide composite positive electrode materials coated with copper oxide in-situ according to different embodiments of the disclosure;

FIG. 3 shows a charge-discharge graph of a sodium-ion battery at 2.5V-4.2V according to Embodiment 1 of the disclosure;

FIG. 4 shows a comparison chart of cycle curves of a sodium-ion battery according to Embodiment 1 of the disclosure;

FIG. 5 shows XRD patterns of an oxide composite positive electrode material coated with copper oxide in-situ after immersion in deionized water for 48 hours according to Embodiment 1 of the disclosure;

FIG. 6 shows a comparison chart of charge-discharge curves of an oxide composite positive electrode material coated with copper oxide in-situ at 2.5V-4.2V after immersion in deionized water for 48 hours according to Embodiment 1 of the disclosure; and

FIG. 7 shows XRD patterns of an oxide composite positive electrode material coated with copper oxide in-situ after immersion in deionized water for 48 hours according to Embodiment 1 of the disclosure.

### DETAILED DESCRIPTION

The technical solutions of the disclosure will be further described in detail below in combination with the accompanying drawings and embodiments.

An embodiment of the disclosure provides an oxide composite positive electrode material coated with copper oxide in-situ, which has a chemical general formula of: γCuO-NaₐCu_{b}Mn_{c}MaO_{2+β};

In the oxide composite positive electrode material, Cu, Mn and M together occupy a transition metal site in a crystal structure; M is an element introduced through doping to substitute for the transition metal site, and includes one or more of elements of group IIIA, elements of group IV, elements of group VA,non-metallic elements of group VIA, transition metal elements of the fourth periods or transition metal elements of the fifth periods;
a, b, c, d and 2+β corresponding to molar percents of corresponding elements, respectively, and respective components in the chemical general formula satisfy conservation of charge and stoichiometric conservation, wherein b+c+d=1, a+2b+4c+md=2 (2+B), 0.66≤a≤1, 0<b≤0.5, 0<c≤0.8, 0<d≤0.65, −0.05≤B≤0.05, and m is a valence state of M;
the oxide composite positive electrode material is layered, and has a space group of P63/mmc or P63/mcm with a corresponding structure of a P2 phase, or a space group is R3̅m with a corresponding structure of an O3 phase, or a space group is a mixture of P63/mcm and R3̅m with a corresponding structure of a P2/O3 mixed phase;
and γCuO is a coating layer generated in-situ on a surface of NaₐCu_{b}Mn_{c}MaO₂+B by the Cu element added in excess during a sintering process for preparing the positive electrode material, and γ is a molar ratio of the excessive Cu element in a precursor material, with 0.1%≤γ≤10%, preferably, 2%≤γ≤6%.

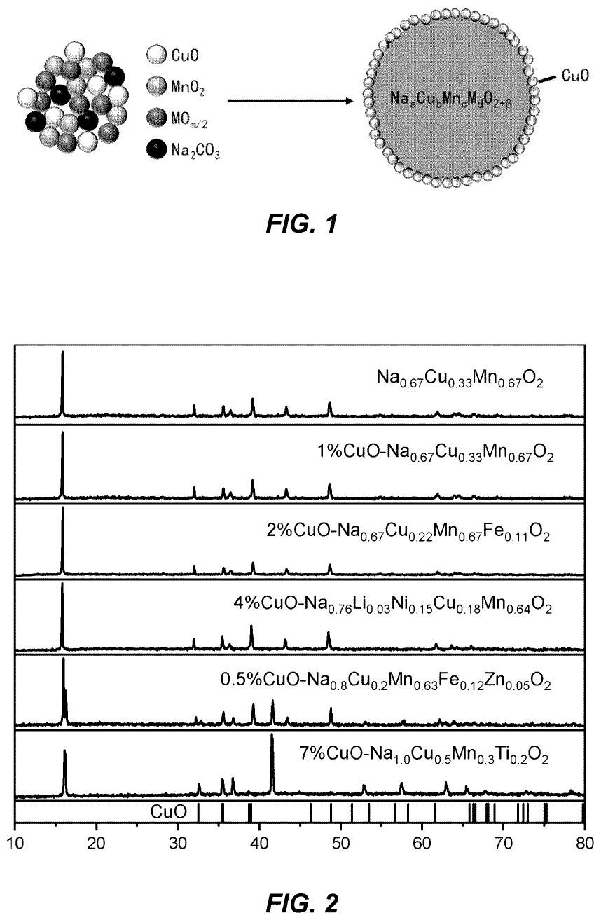

In the process of sintering to prepare a copper-based oxide material, based on the fact that the solid solubility of copper is lower than that of other elements, copper added to a precursor in excess cannot be solubilized into the bulk phase of the material during the sintering process, but enriched on the surfaces of particles in the form of copper oxide to evenly and completely wrap the layered oxide positive electrode, thereby producing a copper oxide coating layer in-situ. The process is schematically shown in FIG. 1.

Due to the dense and uniform copper oxide coating layer, residual alkali generated due to contact of the surface of the material with the air is greatly reduced, the stability in air is greatly improved, and the material achieves higher conductivity and sodium diffusion capability, lower charge transfer impedance, higher initial charge-discharge efficiency, better cycling performance and, in particular, longer cycle life, such that the oxide composite positive electrode material coated with copper oxide in-situ on a surface achieves characteristics such as air stability, high capacity and high cycle stability, and can still maintain structural stability after being held in the air with 45% RH-60% RH for more than 48 hours.

The copper-based oxide material coated with copper oxide in-situ according to the disclosure can be used in a positive electrode piece, which is prepared by mixing the copper-based oxide material coated with copper oxide in-situ described above with a conductive additive and a binder, and then coating the resulting mixture on a current collector. The conductive additive, binder and current collector used may be the conductive additive, binder and current collector commonly used in the positive electrode of a sodium-ion battery in the prior art, which are not specially defined here.

In the test of a half battery loaded with the positive electrode piece described above, it is found that the material not only has high mass specific capacity (which is 1.5-2 times that of an ordinary positive electrode material of a sodium-ion battery) and high specific energy, but also has a good cycle life and great practical value. The oxide composite positive electrode material, that can be coated with copper oxide in-situ, according to the disclosure is for use in large-scale energy storage equipment in solar power generation, wind power generation, peak load regulation of the smart power grid, distributed power stations, back-up sources or communication base stations.

The oxide composite positive electrode material coated with copper oxide in-situ according to the disclosure may be prepared by the methods as follows.

In a first method, a solid-phase method is used for preparation and mainly includes the steps of:
S1, mixing sodium carbonate with a stoichiometric amount of 100 wt %-108 wt % of sodium as required, an oxide of copper with a stoichiometric amount of 100.1 wt %-110 wt % of copper as required, and an oxide of manganese or a carbonate of manganese with a stoichiometric amount as required and an oxide of M or a carbonate of M with a stoichiometric amount as required to form a positive electrode material precursor, with M defined as above;
S2, mixing the positive electrode material precursor uniformly by ball milling to obtain precursor powder;
S3, placing the precursor powder in a muffle furnace or a tube furnace, and thermally treating the precursor powder in an air or oxygen atmosphere at 600° C.-1000° C. for 2-24 hours; and
S4, grinding the thermally treated powder to obtain the oxide composite positive electrode material coated with copper oxide in-situ.

In a second method, a spray-drying method is used for preparation and mainly includes the steps of:
S1, mixing sodium carbonate or sodium nitrate with a stoichiometric amount of 100 wt %-110 wt % of sodium as required, a nitrate of copper with a stoichiometric amount of 100.1 wt %-110 wt % of copper as required, a nitrate of manganese with a stoichiometric amount as required and an oxide of M or a carbonate of M with a stoichiometric amount as required to form a positive electrode material precursor, with M defined as above;
S2, adding ethanol or water to the positive electrode material precursor, and stirring evenly to form a slurry;
S3, spray-drying the slurry to obtain precursor powder;
S4, placing the precursor powder in a muffle furnace or a tube furnace, and thermally treating the precursor powder in an air or oxygen atmosphere at 600° C.-1000° C. for 2-24 hours; and
S5, grinding the thermally treated powder to obtain the oxide composite positive electrode material coated with copper oxide in-situ on a surface.

In a third method, a burning method is used for preparation and mainly includes the steps of:
S1, mixing sodium nitrate with a stoichiometric amount of 100 wt %-110 wt % of sodium as required, a nitrate of copper with a stoichiometric amount of 100.1 wt %-110 wt % of copper as required, a nitrate of manganese with a stoichiometric amount as required and a nitrate of M with a stoichiometric amount as required to form a positive electrode material precursor, with M defined as above;
S2, adding acetylacetone to the positive electrode material precursor, and stirring evenly to form a slurry;
S3, drying the slurry to obtain precursor powder;
S4, placing the precursor powder in a muffle furnace or a tube furnace, and thermally treating the precursor powder in an air or oxygen atmosphere at 600° C.-1000° C. for 2-24 hours; and
S5, grinding the thermally treated powder to obtain the oxide composite positive electrode material coated with copper oxide in-situ on a surface.

In a fourth method, a sol-gel method is used for preparation and mainly includes the steps of:
S1, dissolving and mixing a sodium salt with a stoichiometric amount of 100 wt %-110 wt % of sodium as required, a nitrate of copper or a sulfate of copper with a stoichiometric amount of 100.1 wt %-110 wt % of copper as required, a nitrate of manganese or a sulfate of manganese with a stoichiometric amount and a nitrate of M or a sulfate of M with a stoichiometric amount as required in water or ethanol to form a precursor solution,
With M defined as above and the sodium salt including one or more of sodium acetate, sodium nitrate, sodium carbonate or sodium sulfate;
S2, stirring the precursor solution at 50° C.-100° C., adding a chelating agent with an amount 2-6 times a total molar amount of transition metal, and evaporating a resultant to dryness to form a precursor gel, wherein the transition metal includes Cu and M;
S3, placing the precursor gel in a crucible, and pre-sintering the precursor gel at 200° C.-500° C. in an air atmosphere for 2 hours;
S4 placing powder resulting from the pre-sintering in a muffle furnace or tube furnace, and thermally treating the powder in an air or oxygen atmosphere at 600° C.-1000° C. for 2-24 hours; and
S5, grinding the thermally treated powder to obtain the oxide composite positive electrode material coated with copper oxide in-situ on a surface.

In a fifth method, a co-precipitation method is used for preparation and mainly includes the steps of:
S1, dissolving and mixing a nitrate of copper with a stoichiometric amount of 100.1 wt %-110 wt % of copper as required, and a nitrate of manganese with a stoichiometric amount as required and a nitrate of M with a stoichiometric amount as required in water to form a precursor solution, with M defined as above;
S2, dropwise adding the precursor solution into an aqueous ammonia solution with a pH between 7 and 14 by using a peristaltic pump to produce a precipitate;
S3, cleaning the obtained precipitate with deionized water, drying the precipitate, and mixing the precipitate and sodium carbonate with a stoichiometric amount of 100 wt %-110 wt % of sodium as required evenly at a stoichiometric ratio to obtain a precursor;
S4, placing the precursor in a crucible or porcelain boat, and thermally treating the precursor in an air or oxygen atmosphere at 600° C.-1000° C. for 2-24 hours; and
S5, grinding the thermally treated powder to obtain the oxide composite positive electrode material coated with copper oxide in-situ on a surface.

For better understanding of the technical solutions provided by the disclosure, a plurality of specific examples are described below respectively to illustrate the specific processes of preparing the oxide composite positive electrode material coated with copper oxide in-situ using several methods provided in the aforementioned embodiments of the disclosure, methods for applying the oxide composite positive electrode material to sodium-ion secondary batteries, and the properties of the batteries.

### Embodiment 1

In this embodiment, the oxide composite positive electrode material coated with copper oxide in-situ is prepared with a solid-phase method.

Na₂CO₃ (analytically pure) and MnO₂ (analytically pure) each with a stoichiometric amount as required were mixed with CuO (analytically pure) with a stoichiometric amount of 101 wt % of copper as required and CuO (analytically pure) (Comparative Example) with a stoichiometric amount of 100 wt % of copper as required, respectively, based on the stoichiometric amount, ball-milled in an agate mortar for half an hour, respectively, to obtain two positive electrode material precursors, one of which was excessive in CuO and the other of which is not excessive in CuO (as Comparative Example).

The two positive electrode material precursors were transferred into an Al₂O₃crucible respectively, and treated in a muffle furnace in an oxygen atmosphere at 900° C. for 15 hours to obtain black powder, layered oxide materials Na_{0.67}Cu_{0.33}Mn_{0.6}O₂ (CuO obtained not in excess) and 1% CuO—Na_{0.67}Cu_{0.33}Mn_{0.6}O₂ (CuO obtained in excess), with XRD patterns shown in FIG. 2.

From the XRD patterns, Na_{0.67}Cu_{0.33}Mn_{0.6}O₂ and 1% CuO—Na_{0.67}Cu_{0.33}Mn_{0.6}O₂ were each an oxide with a crystal structure being a P2-phase layered structure. Its space group is P63/mmc.

The oxide composite positive electrode material coated with copper oxide in-situ prepared above is used as the active substance of a battery's positive electrode material for preparing a sodium-ion battery.

The specific steps were as follows. The prepared powder 1% CuO—Na_{0.67}Cu_{0.33}Mn_{0.6}O₂ was mixed with acetylene black and a binder polyvinylidene fluoride (PVDF) at a mass ratio of 80:10:10; a proper amount of N-methyl pyrrolidone (NMP) solution was added; the resulting mixture was ground at normal temperature in a dry environment to form a slurry; then, the slurry was uniformly coated on an aluminum foil of a current collector and dried under an infrared lamp; and the coated aluminum foil was cut into electrode pieces of (8×8) mm2. The electrode pieces were dried at 110° C. in vacuum for 10 hours, and then transferred to a glove box for later use.

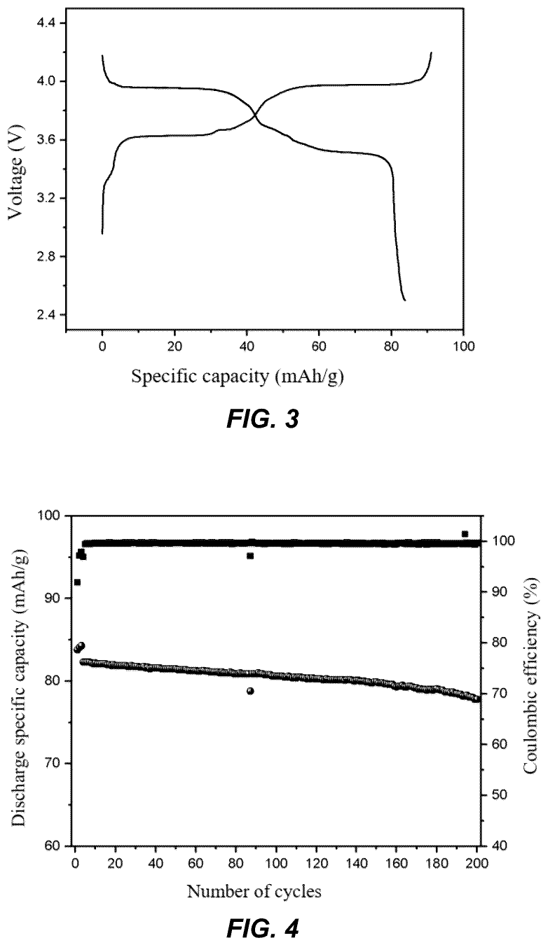

The assembly of a simulated battery was conducted in the glove box in an Ar atmosphere, by which a CR2032 button battery was assembled with metallic sodium as a counter electrode and 1 mol/L NaClO₄/diethyl carbonate (DEC) solution as electrolyte. In a constant current charge-discharge mode, a charge-discharge test was conducted at the current densities of C/10 and 1.0C. With the discharge cutoff voltage of 2.5V and the charge cutoff voltage of 4.2V, the results of the charge-discharge test at 2.5V-4.2V were shown in FIG. 3, and the battery cycle curves were shown in FIG. 4.

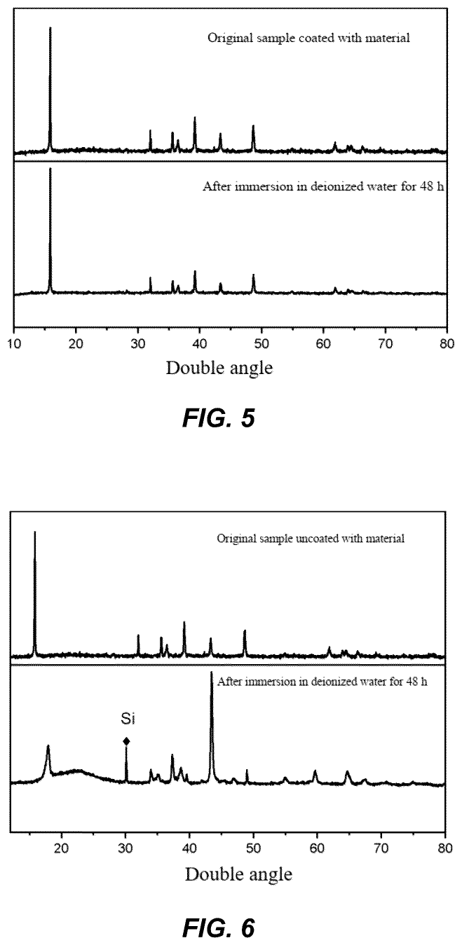

Furthermore, the oxide composite positive electrode material coated with copper oxide in-situ on the surface as prepared in Embodiment 1 was compared with the oxide positive electrode material uncoated with copper oxide before and after immersion in deionized water for 48 hours. FIG. 5 and FIG. 6 are comparative XRD patterns before and after the immersion. As can be seen, the XRD patterns of the oxide composite positive electrode material coated with copper oxide in-situ on the surface do not show significant changes before and after immersion in the deionized water for 48 hours, while the XRD patterns of the oxide positive electrode material uncoated with copper oxide show significant changes before and after immersion in the deionized water for 48 hours. This indicates that the oxide composite positive electrode material coated with copper oxide in-situ on the surface prepared according to the disclosure greatly improves the stability of the material in water.

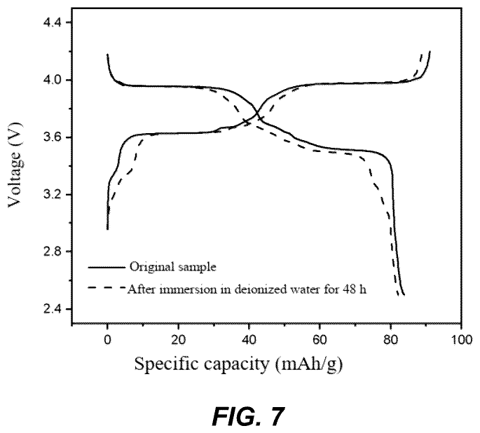

The layered oxide materials obtained before and after immersion in deionized water are used as the active substances of a battery's positive electrode material for preparing a sodium-ion battery, and subjected to an electrochemical charge-discharge test. The preparation process and test method are the same as in Embodiment 1, with the test voltage in a range of 2.5V-4.2V. FIG. 7 shows the results of the charge-discharge test. In terms of the charge-discharge curves and the reversible specific capacity, the coating layer greatly improves the stability of the material in water, further demonstrating that the coating layer can improve the air stability of the material.

### Embodiment 2

In this embodiment, the oxide composite positive electrode material coated with copper oxide in-situ is prepared with a solid-phase method.

Na₂CO₃ (analytically pure), MnO₂ (analytically pure) and Fe₂O₃ (analytically pure) each with a stoichiometric amount as required were mixed with CuO (analytically pure) with a stoichiometric amount of 102 wt % of copper as required based on the stoichiometric amount, and ball-milled in an agate mortar for half an hour to obtain a precursor.

The precursor was transferred into an Al₂O₃ crucible, and treated in a muffle furnace in an oxygen atmosphere at 900° C. for 15 hours to obtain black powder, a layered oxide material 2% CuO—Na_{0.67}Cu_{0.22}Mn_{0.67}Fe_{0.11}O₂, with an XRD pattern shown in FIG. 2.

From the XRD pattern, 2% CuO—Na_{0.67}Cu_{0.22}Mn_{0.67}Fe_{0.11}O₂ was an oxide with a crystal structure being a P2-phase layered structure. Its space group is P63/mmc.

The oxide composite positive electrode material coated with copper oxide in-situ prepared above is used as the active substance of a battery's positive electrode material for preparing a sodium-ion battery, and subjected to an electrochemical charge-discharge test. The preparation process and test method of the battery are the same as that in Embodiment 1. The test voltage is in a range of 2.5V-4.2V, and the reversible specific capacity of the material is as shown in Table 1.

### Embodiment 3

In this embodiment, the oxide composite positive electrode material coated with copper oxide in-situ is prepared with a solid-phase method.

Na₂CO₃ (analytically pure), LizCO3 (analytically pure), NiO (analytically pure) and MnO₂ (analytically pure) each with a stoichiometric amount as required were mixed-base on the stoichiometric amount, with CuO (analytically pure) with a stoichiometric amount of 104 wt % of copper as required, and ball-milled in an agate mortar for half an hour to obtain a precursor.

The precursor was transferred into an Al₂O₃ crucible, and treated in a muffle furnace in an oxygen atmosphere at 900° C. for 15 hours to obtain black powder, a layered oxide material 4% CuO—Na_{0.76}Li_{0.03}Ni_{0.15}Cu_{0.18}Mn_{0.64}O₂, with an XRD pattern shown in FIG. 2.

From the XRD pattern, 4% CuO—Na_{0.76}Li_{0.03} Ni_{0.15}Cu_{0.18}Mn_{0.64}O₂ was an oxide with a crystal structure being a P2-phase layered structure. Its space group is P63/mmc.

The oxide composite positive electrode material coated with copper oxide in-situ prepared above is used as the active substance of a battery's positive electrode material for preparing a sodium-ion battery, and subjected to an electrochemical charge-discharge test. The preparation process of and test method the battery are the same as that in Embodiment 1. The test voltage is in a range of 2.5V-4.2V, and the reversible specific capacity of the material is as shown in Table 1.

### Embodiment 4

In this embodiment, the oxide composite positive electrode material coated with copper oxide in-situ is prepared with a solid-phase method.

Na₂CO₃ (analytically pure), MnO₂ (analytically pure), Fe₂O₃ (analytically pure) and ZnO (analytically pure) each with a stoichiometric amount as required were mixed based on the stoichiometric amount, with CuO (analytically pure) having a stoichiometric amount of 100.5 wt % of copper as required, and ball-milled in an agate mortar for half an hour to obtain a precursor.

The precursor was transferred into an Al₂O₃ crucible, and treated in a muffle furnace in an oxygen atmosphere at 900° C. for 15 hours to obtain black powder, a layered oxide material 0.5% CuO—Na_{0.8}Cu_{0.2}Mn_{0.63}Fe_{0.12}Zn_{0.05}O₂, with an XRD pattern shown in FIG. 2.

From the XRD pattern, 0.5% CuO—Na_{0.8}Cu_{0.2}Mn_{0.63}Fe_{0.12}Zn_{0.05}O₂ was an oxide with a crystal structure being a P2/O3 mixed phase structure. Its space group is a mixture of P63/mmc and R3̅m.

The oxide composite positive electrode material coated with copper oxide in-situ prepared above is used as the active substance of a battery's positive electrode material for preparing a sodium-ion battery, and subjected to an electrochemical charge-discharge test. The preparation process and test method of the battery are the same as that in Embodiment 1. The test voltage is in a range of 2.5V-4.2 V, and the reversible specific capacity of the material is as shown in Table 1.

### Embodiment 5

In this embodiment, the oxide composite positive electrode material coated with copper oxide in-situ is prepared with a solid-phase method.

Na₂CO₃ (analytically pure), MnO₂ (analytically pure) and TiO₂ (analytically pure) each with a stoichiometric amount as required were mixed based on the stoichiometric amount, with CuO (analytically pure) with a stoichiometric amount of 107 wt % of copper as required, and ground in an agate mortar for half an hour to obtain a precursor.

The precursor was transferred into an Al₂O₃ crucible, and treated in a muffle furnace in an oxygen atmosphere at 900° C. for 15 hours to obtain black powder, a layered oxide material 7% CuO—Na_{1.0}Cu_{0.5}Mn_{0.3} Ti_{0.2}O₂, with an XRD pattern shown in FIG. 2.

From the XRD pattern, 7% CuO—Na_{1.0}Cu_{0.5}Mn_{0.3}Ti_{0.2}O₂ was an oxide with a crystal structure being an 03-phase structure. Its space group is R3̅m.

The oxide composite positive electrode material coated with copper oxide in-situ prepared above is used as the active substance of a battery's positive electrode material for preparing a sodium-ion battery, and subjected to an electrochemical charge-discharge test. The preparation process and test method of the battery are the same as that in Embodiment 1. The test voltage is in a range of 2.5 V-4.2 V, and the reversible specific capacity of the material is as shown in Table 1.

TABLE 1

| | | | Capacity |
|---|---|---|---|
| | | | retention ratio |
| | | Reversible | after 200 cycles |
| | | specific capacity | at 1.0 C and 2.5 |
| Embodiment | Composition | (mAh/g) | V −4.2 V |
| 1 | 1% CuO—Na_{0.67}Cu_{0.33}Mn_{0.6}O₂ | 83.9 | 95.10% |
| 2 | 2% CuO—Na_{0.67}Cu_{0.22}Mn_{0.67}Fe_{0.11}O₂ | 87.2 | 96.30% |
| 3 | 4% CuO—Na_{0.76}Li_{0.03}Ni_{0.15}Cu_{0.18}Mn_{0.64}O₂ | 98.4 | 92.70% |
| 4 | 0.5% CuO—Na_{0.8}Cu_{0.2}Mn_{0.63}Fe_{0.12}Zn_{0.05}O₂ | 110.7 | 87.80% |
| 5 | 7% CuO—Na_{1.0}Cu_{0.5}Mn_{0.3}Ti_{0.2}O₂ | 145.5 | 80.40% |
| Comparative | Na_{0.67}Cu_{0.33}Mn_{0.6}O₂ | 80.2 | 67.38% |
| Example | | | |

Through comparison, it can be seen that the oxide composite positive electrode material coated with copper oxide in-situ as prepared by the disclosure has better performance than the positive electrode material uncoated with copper oxide in terms of reversible specific capacity and capacity retention rate in cycles at 1.0C.

While the embodiments above illustrate the specific implementation of the solutions of the disclosure in detail by only taking the solid-phase method as an example, the spray-drying, burning, sol-gel and co-precipitation methods provided in the disclosure are all well known to those skilled in the art. The technical solutions of the disclosure can be achieved by those skilled in the art according to the steps of the preparation processes of the preparation methods provided above by the disclosure, without making creative effort.

The objects, technical solutions and beneficial effects of the disclosure are further explained in detail in the specific embodiments described above. It should be understood that the description above only involves the specific embodiments of the disclosure and is not intended to limit the protection scope of the disclosure. Any modifications, equivalent substitutions, improvements and the like made within the spirit and principle of the disclosure shall be construed as being included within the protection scope of the disclosure.

1. An oxide composite positive electrode material coated with copper oxide in-situ, which has a chemical general formula of: γCuO—NaₐCu_{b}Mn_{c}M_{d}O₂+β,
wherein in the oxide composite positive electrode material, Cu element, Mn element, and M together occupy a transition metal site in a crystal structure; M is an element introduced through doping to substitute for the transition metal site, and comprises one or more of elements of group IIIA, elements of group IV, elements of group VA, non-metallic elements of group VIA, transition metal elements of period four, or transition metal elements of period five;
the oxide composite positive electrode material is layered, and has a space group of P63/mmc or P63/mcm with a corresponding structure of a P2 phase, or a space group is R3̅m with a corresponding structure of an O3 phase, or a space group is a mixture of P63/mcm and R3̅m with a corresponding structure of a P2/O3 mixed phase;
a, b, c, d and 2+β corresponding to molar percents of corresponding elements, respectively, and respective components in the chemical general formula satisfy conservation of charge and stoichiometric conservation, wherein b+c+d=1, a+2b+4c+md=2 (2+β), 0.66≤a≤1, 0<b≤0.5, 0<c≤0.8, 0<d≤0.65,−0.05≤B≤0.05, and m is a valence state of M; and
γCuO is a coating layer generated in-situ on a surface of NaₐCu_{b}Mn_{c}MaO_{2+β} by the Cu element added in excess during a sintering process for preparing the positive electrode material, and γ is a molar ratio of the Cu element added in excess in a precursor material, with 0.1%≤γ≤10%.

2. The oxide composite positive electrode material coated with copper oxide in-situ according to claim 1, wherein 2%<γ<6%.

3. A preparation method for the oxide composite positive electrode material coated with copper oxide in-situ according to claim 1,
wherein the preparation method is a solid-phase method, comprising:
mixing sodium carbonate with a stoichiometric amount of 100 wt %-108 wt % of sodium, an oxide of copper with a stoichiometric amount of 100.1 wt %-110 wt % of copper, and an oxide of manganese or a carbonate of manganese with a stoichiometric amount and an oxide of M or a carbonate of M with a stoichiometric amount to form a positive electrode material precursor, wherein M is the element introduced through doping to substitute for the transition metal site, and comprises one or more of the elements of group IIIA, the elements of group IV, the elements of group VA, the non-metallic elements of group VIA, the transition metal elements of period four, or the transition metal elements of period five;
mixing the positive electrode material precursor uniformly by ball milling to obtain precursor powder;
placing the precursor powder in a muffle furnace or a tube furnace, and thermally treating the precursor powder in an air or oxygen atmosphere at 600° C.-1000° C. for 2-24 hours; and
grinding the thermally treated precursor powder to obtain the oxide composite positive electrode material coated with copper oxide in-situ.

4. A preparation method for the oxide composite positive electrode material coated with copper oxide in-situ according to claim 1,
wherein the preparation method is a spray-drying method, comprising:
mixing sodium carbonate or sodium nitrate with a stoichiometric amount of 100 wt %-110 wt % of sodium as required, a nitrate of copper with a stoichiometric amount of 100.1 wt %-110 wt % of copper as required, a nitrate of manganese with a stoichiometric amount as required and an oxide of M or a carbonate of M with a stoichiometric amount as required to form a positive electrode material precursor, wherein M is the element introduced through doping to substitute for the transition metal site, and comprises one or more of the elements of groups IIIA, the elements of groups IV, the elements of groups VA, the non-metallic elements of group VIA, the transition metal elements of period four, or the transition metal elements of period five;
adding ethanol or water to the positive electrode material precursor, and stirring evenly to form a slurry;
spray-drying the slurry to obtain precursor powder;
placing the precursor powder in a muffle furnace or a tube furnace, and thermally treating the precursor powder in an air or oxygen atmosphere at 600° C.-1000° C. for 2-24 hours; and
grinding the thermally treated precursor powder to obtain the oxide composite positive electrode material coated with copper oxide in-situ on a surface.

5. A preparation method for the oxide composite positive electrode material coated with copper oxide in-situ according to claim 1,
wherein the preparation method is a burning method, comprising:
mixing sodium nitrate with a stoichiometric amount of 100 wt %-110 wt % of sodium as required, a nitrate of copper with a stoichiometric amount of 100.1 wt %-110 wt % of copper as required, a nitrate of manganese with a stoichiometric amount as required and a nitrate of M with a stoichiometric amount as required to form a positive electrode material precursor, wherein M is the element introduced through doping to substitute for the transition metal site, and comprises one or more of the elements of group IIIA, the elements of group IV, the elements of group VA, the non-metallic elements of group VIA, the transition metal elements of period four, or transition metal elements of period five;
adding acetylacetone to the positive electrode material precursor, and stirring evenly to form a slurry;
drying the slurry to obtain precursor powder;
placing the precursor powder in a muffle furnace or a tube furnace, and thermally treating the precursor powder in an air or oxygen atmosphere at 600° C.-1000° C. for 2-24 hours; and
grinding the thermally treated precursor powder to obtain the oxide composite positive electrode material coated with copper oxide in-situ on a surface.

6. A preparation method for the oxide composite positive electrode material coated with copper oxide in-situ according to claim 1,
wherein the preparation method is a sol-gel method, comprising:
dissolving and mixing a sodium salt with a stoichiometric amount of 100 wt %-110 wt % of sodium as required, a nitrate of copper or a sulfate of copper with a stoichiometric amount of 100.1 wt %-110 wt % of copper as required, a nitrate of manganese or a sulfate of manganese with a stoichiometric amount and a nitrate of M or a sulfate of M with a stoichiometric amount as required in water or ethanol to form a precursor solution, wherein M is the element introduced through doping to substitute for the transition metal site, and comprises one or more of the elements of group IIIA, the_elements of group IV, the elements of group VA, the non-metallic elements of group VIA, the transition metal elements of period four, or the transition metal elements of period five, and the sodium salt comprises: sodium acetate, sodium nitrate, sodium carbonate or sodium sulfate;
stirring the precursor solution at 50° C.-100° C., adding a chelating agent with an amount 2-6 times the total molar amount of transition metal, and evaporating the resultant to dryness to form a precursor gel, wherein the transition metal comprises Cu and M;
placing the precursor gel in a crucible, and pre-sintering the precursor gel at 200° C.-500° C. for 2 hours;
placing powder resulting from the pre-sintering in a muffle furnace or tube furnace, and thermally treating the powder in an air or oxygen atmosphere at 600° C.-1000° C. for 2-24 hours; and
grinding the thermally treated powder to obtain the oxide composite positive electrode material coated with copper oxide in-situ on a surface.

7. A preparation method for the oxide composite positive electrode material coated with copper oxide in-situ according to claim 1,
wherein the preparation method is a co-precipitation method, comprising:
dissolving and mixing a nitrate of copper with a stoichiometric amount of 100.1 wt %-110 wt % of copper as required, a nitrate of manganese with a stoichiometric amount as required and a nitrate of M with a stoichiometric amount as required in water to form a precursor solution, wherein M is the element introduced through doping to substitute for the transition metal site, and comprises one or more of the elements of group IIIA, the elements of group IV, the elements of group VA, the non-mettalic elements of group VIA, the transition metal elements of the period four, or the transition metal elements of period five;
dropwise adding the precursor solution into an aqueous ammonia solution with a pH between 7 and 14 by using a peristaltic pump to produce a precipitate;
cleaning an obtained precipitate with deionized water, drying the precipitate, and mixing the precipitate and sodium carbonate with a stoichiometric amount of 100 wt %-110 wt % of sodium as required evenly at a stoichiometric ratio to obtain a precursor;
placing the precursor in a crucible or porcelain boat, and thermally treating the precursor in an air or oxygen atmosphere at 600° C.-1000° C. for 2-24 hours; and
grinding the thermally treated precursor powder to obtain the oxide composite positive electrode material coated with copper oxide in-situ on a surface.

8. A positive electrode piece for a sodium-ion secondary battery, comprising a current collector, a conductive additive coated on the current collector, a binder, and the oxide composite positive electrode material coated with copper oxide in-situ according to claim 1.

9. A sodium-ion secondary battery comprising the positive electrode piece according to claim 8.

10. Use of the sodium-ion secondary battery according to claim 9, wherein the sodium-ion secondary battery is for use in large-scale energy storage equipment in solar power generation, wind power generation, peak load regulation of a smart power grid, distributed power stations, back-up sources or communication base stations.
